(19) United States
(12) Patent Application Publication
(10) Pub. No.: US 2008/0313622 A1
(43) Pub. Date: Dec. 18, 2008

(54) Low-Level Connectivity Admission Control for Networked Consumer Storage Devices

(76) Inventor: Jozef Pieter Van Gassel, Tampere (FI)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/629,055

(22) PCT Filed: May 26, 2005
(86) PCT No.: PCT/IB2005/051728

§ 371 Date: Mar. 25, 2008

(30) Foreign Application Priority Data
Jun. 10, 2004 (EP) 04102639.4

(51) Int. Cl. G06F 9/44

(52) U.S. Cl. 717/161

(57) ABSTRACT

The present invention relates to a device and a method of accessing a storage of a storage device by reading or writing data to said storage device, wherein said accessing is controlled by an external data controller via a low level in a software stack of said device, and wherein said storage device is accessed without hampering the operation of functionalities at a higher level of said software stack of said device, said device comprises an intermediate storage, and the method comprises the steps of storing commands related to said accessing of data in said intermediate storage as a command queue, executing said commands in said command queue when allowed by a command queue scheduler, said scheduler scheduling in dependence of at least one of the functionalities at said higher level of said software stack. Thereby full control is obtained on storage medium requests by the scheduler.

The present invention relates to a device and a method for receiving and downloading data from a data provider without hampering the operation of the device.

In the last years the number of different mobile products has increased significantly. Among such products are connected mobile consumer electronic products, such as mobile optical, HDD or Flash based MP3-players, picture and MP3 key rings and last but not least HDI) based Personal Infotainment Devices. These types of products are capable (or will be in future generations) of rendering high-quality audio and video streams from local or networked storage. Almost all of these devices are connected via USB and IEEE 1394 using respectively the Mass Storage Profile and the SBP-2 protocols. Both of these standards are low-level block-based protocols that simply package ATA-like (e.g. HDD or CD/DVD) commands into their native packets and send them over the interface to the storage device.

The problem, however, is that access at this low block-level in the software stack interferes with higher level storage schedulers that guarantee quality of service or reduce power consumption for mobile devices. Thereby, using USB or IEEE 1394 while streaming audio/video in such systems might seriously hamper the scheduler's operation, because storage access is outside of control of the scheduler algorithm.

It is the object of the present invention to solve or at least alleviate the above-mentioned problems.

This is obtained by a method of accessing a storage of a storage device by reading or writing data to said storage device, wherein said accessing is controlled by an external data controller via a low level in a software stack of said device, said device comprises an intermediate storage, and the method comprises the steps of:
storing commands related to said accessing of data in said intermediate storage as a command queue,
executing said commands in said command queue when allowed by a command queue scheduler, said scheduler scheduling in dependence of at least one of the functionalities at said higher level of said software stack.

Thereby full control is obtained on storage medium requests by the scheduler. Real time functionalities, such as real time file requests, can now be performed without being interrupted by lower level operations, such as disc access. This can be obtained because the scheduler handling the queue schedules in accordance with the functionalities at the higher level of a software stack. The scheduler could e.g. schedule the commands in the command queue to be executed in suitable time periods, where the functionalities at the higher levels are not so time critical.

In an embodiment the functionalities at a higher level comprise the functionality of a storage scheduler, and the command queue scheduler schedules in dependence of said higher level storage scheduler. Specifically, when the higher levels comprise a storage scheduler it is of interest that it also controls the incoming command requests relating to storage access. Thereby the storage scheduler could e.g. schedule to save power by avoiding too many spin ups and downs of a disc by keeping commands in the command queue until a time where the disc has to be spun up anyway.

In an embodiment said higher level storage scheduler also performs the operation of said command queue scheduler.

Thereby the scheduler does not have to be implemented separately, requiring fewer resources from the mobile device, such as memory and processor power.

In an embodiment the data to be read or written on said storage device is multimedia content such as audio or video, and wherein said higher level storage scheduler also schedules the rendering of said multimedia content.

Especially when the higher level functionalities relate to processing of real time data, it is essential that the data are processed without being disturbed from a low level action.

In an embodiment the higher level storage scheduler also schedules the power consumption of said data storage.

The invention further relates to a computer readable medium having stored therein instructions for causing a processing unit in a device for receiving and storing data from a data provider to execute the method described above.

The invention further relates to device comprising a data storage adapted to be accessed from an external data controller via a low level in a software stack, said device is adapted for accessing the data without hampering the operation of functionalities at a higher level of said software stack of said device, the device comprises:
an intermediate storage adapted for storing commands related to said accessing data in said intermediate storage as a command queue,
a command queue scheduler adapted for scheduling the execution of said commands in said command queue, said scheduler scheduling in dependence of at least one of the functionalities at said higher level of said software stack.

In an embodiment the functionalities at said higher level comprise a storage scheduler, wherein said command queue scheduler is adapted for scheduling in dependence of said storage scheduler.

In an embodiment said storage scheduler also performs the operation of said command queue scheduler.

In an embodiment the data to be read or written on said storage device is multimedia content, such as audio or video, and wherein the functionalities at said higher level comprise a stream scheduler for scheduling the rendering of said multimedia content, wherein said command queue scheduler is adapted for scheduling in dependence of said stream scheduler.

In the following the present invention, and in particular preferred embodiments thereof, will be described in more details in connection with accompanying drawing in which

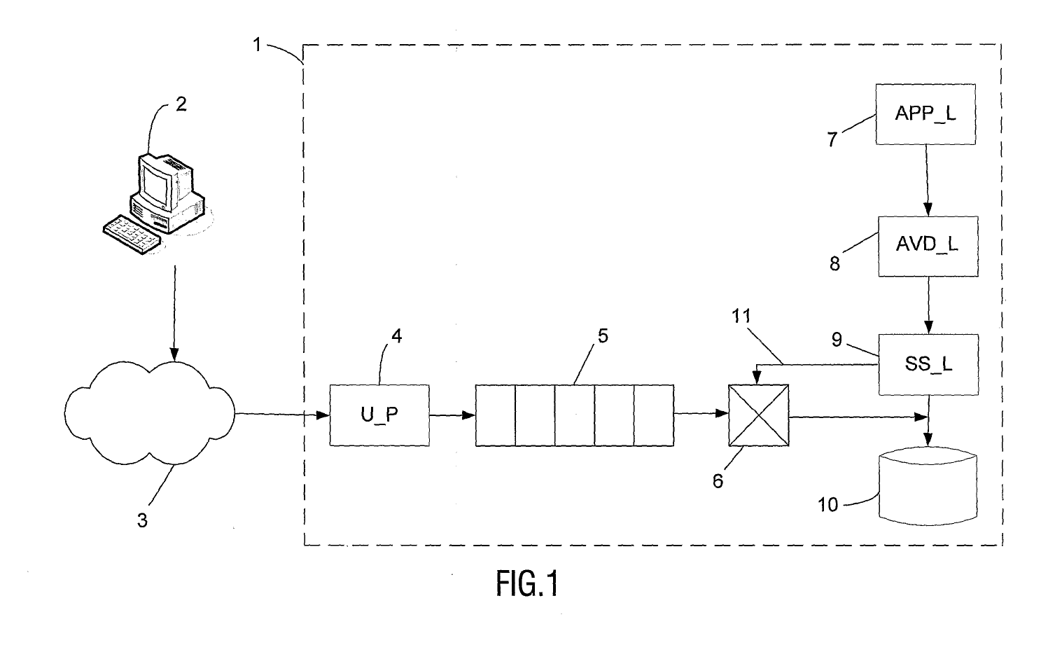

FIG. 1 shows an overview of a mobile device 1 that is interconnected to a data provider 2 through a network,

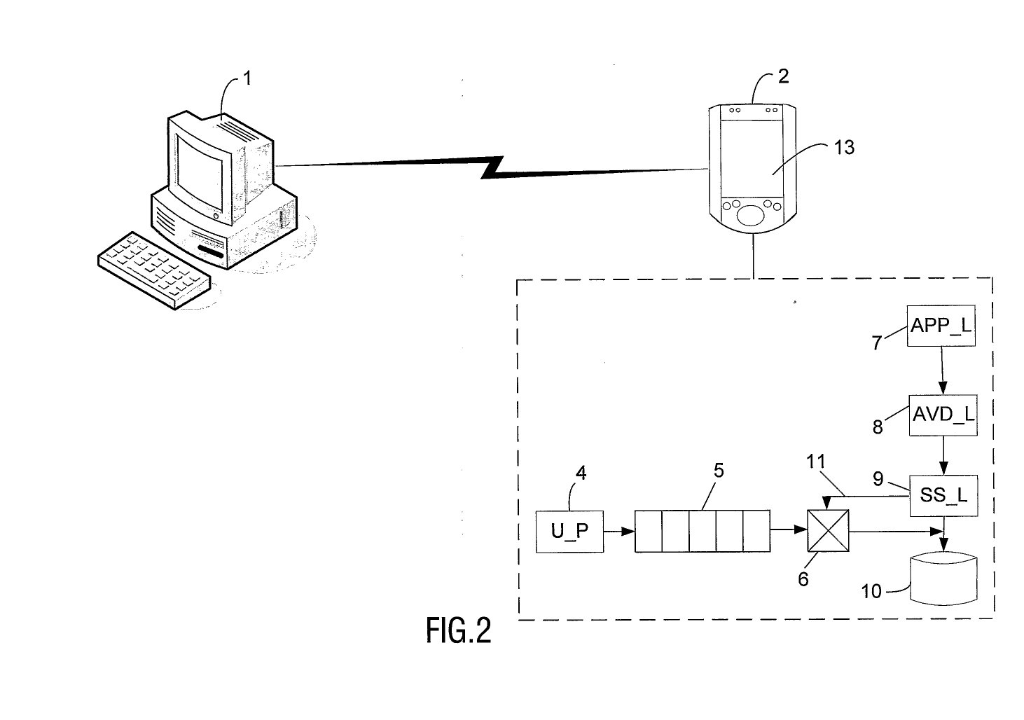

FIG. 2 illustrates an example of a mobile device being a handheld computer being connected to a desktop PC.

FIG. 1 shows an overview of a mobile device 1 that is interconnected to a data controller 2 through a network 3 to receive data from the data controller. As an example the data controller 2 can be a personal computer, the mobile device 1 can be a connected mobile consumer electronic product, such as an MP3 player. The data controller 2 transfers data to the mobile device 1 via the network 3 using a low level block based protocol, such as USB Mass Storage Class or IEEE 1394 SBP-2, which transfer the data by means of packaging the data into ATA-like commands prior to sending the data and commands over the interface to the mobile device 1.

In the embodiment in FIG. 1 the mobile device 1 comprises an unpacking part (U_P) 4, which unpacks the block commands transmitted from the data provider 2 to the mobile device 1, the unpacking part (U_P) 4 receives the packed block command as input, and the output is the unpacked block commands. The actual data flow is bi-directional depending on whether read or write data commands are sent to the mobile device. The data is transported via a separate path, which is not depicted in this figure (this figure shows the control flow). The mobile device further comprises an intermediate storage 5, e.g. in the form of RAM modules, this part is connected to the unpacking part 4 and receives the unpacked block commands from the unpacking part 4. The unpacked block commands are stored in the intermediate storage 5 as a command queue according to the principle first in first out. It is to be noted that buffering of the packaged commands would theoretically also be a possibility The output of the intermediate storage is connected to a valve functionality 6, which based on a control input 11, is either opened and thereby letting block commands through to the data storage or closed and thereby blocking access to the data storage 10. The output of the valve functionality 6 is connected to the data storage 10. Further, the mobile device comprises different software stacks for performing different functionalities. The software stack in the figure is the stack for playing back streamed A/V content, the stack comprises a stream scheduler layer 9 (SS_L), an A/V decoder layer 8 and an application layer 7.

By adding the extra buffer or queue 5 to the device the queue stores all incoming block commands for the bit engine via e.g. the USB, IEEE 1394 or similar digital interface. The output of the queue 5 is controlled by the traditional scheduler 9 in a “valve”-like way. The scheduler 9 is then able to decide whenever the network based block-based requests are executed by controlling the valve 6.

The valve 6 is opened whenever suitable for the scheduler 9. Hence, in case of real-time streaming of audio/video content, the incoming block-based requests do no longer interfere with real-time guarantees that are delivered by the scheduler 9 to higher layers in the software stack. In this way video can be served or rendered without hiccups or other visible artefacts.

As an alternative or supplemental feature, low-power scheduling can be obtained by letting incoming requests be postponed using the command queue in cases where the disk is spun down to save energy. In this way the low-level block-based network request coming in over the digital interface does not have to interfere with low-power energy saving strategy or policy. Hence, the disk is no longer spun up unexpectedly leading to an increase of power consumption. In case of high priority requests, the scheduler can decide to spin up the disk in a more controlled way.

In an embodiment the queue 5 and the valve functionality 6 could be integrated with the storage scheduler implementation.

In FIG. 2 a usage example is given, where the mobile device is a handheld computer, such as a palm, and the mobile device is connected to a data controller 1 being a desktop PC. The devices could e.g. be connected via a wire or wireless using USB or Firewire 1394. In a usage scenario, the mobile device streams video data from its local storage onto the integrated display 13. Simultaneously the mobile device receives audio data from the PC, which could be synchronized at the highest possible speed with the video being played back at the mobile device. Because of the command queue and the command queue scheduler, the video playback is not interrupted by the data transfer.

In an alternative usage scenario the video and audio could be rendered on an externally connected renderer.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of accessing a storage of a storage device by reading or writing data to said storage device, wherein said accessing is controlled by an external data controller via a low level in a software stack of said device, said device comprises an intermediate storage, and the method comprises the steps of:
storing commands related to said accessing of data in said intermediate storage as a command queue,
executing said commands in said command queue when allowed by a command queue scheduler, said scheduler scheduling in dependence of at least one of the functionalities at said higher level of said software stack.

2. A method according to claim 1, wherein the functionalities at a higher level comprise the functionality of a storage scheduler, and wherein said command queue scheduler schedules in dependence of said higher level storage scheduler.

3. A method according to claim 2, wherein said higher level storage scheduler also performs the operation of said command queue scheduler.

4. A method according to claim 1, wherein the data to be read or written on said storage device is multimedia content, such as audio or video, and wherein said higher level storage scheduler also schedules the rendering of said multimedia content.

5. A method according to claim 1, wherein the higher level storage scheduler also schedules the power consumption of said data storage.

6. A method according to claim 1 wherein said storage device is accessed without hampering the operation of functionalities at a higher level of said software stack of said device.

7. A computer readable medium having stored therein instructions for causing a processing unit in a device for receiving and storing data from a data provider to execute the method of claim 1.

8. A device comprising a data storage adapted to be accessed from an external data controller via a low level in a software stack, said device is adapted for accessing the data without hampering the operation of functionalities at a higher level of said software stack of said device, the device comprises:
an intermediate storage adapted for storing commands related to said accessing data in said intermediate storage as a command queue,
a command queue scheduler adapted for scheduling the execution of said commands in said command queue, said scheduler scheduling in dependence of at least one of the functionalities at said higher level of said software stack.

9. A device according to claim 8, wherein the functionalities at said higher level comprise a storage scheduler, wherein said command queue scheduler is adapted for scheduling in dependence of said storage scheduler.

10. A device according to claim 9, wherein said storage scheduler also performs the operation of said command queue scheduler.

11. A device according to claim 8, wherein the data to be read or written on said storage device is multimedia content, such as audio or video, and wherein the functionalities at said higher level comprise a stream scheduler for scheduling the rendering of said multimedia content, wherein said command queue scheduler is adapted for scheduling in dependence of said stream scheduler.
